(19) United States
(12) Patent Application Publication
(10) Pub. No.: US 2013/0026289 A1
(43) Pub. Date: Jan. 31, 2013

(54) ENERGY ABSORPTION STRUCTURE

(71) Applicant: Kenji Uegaki, Susono-shi (JP)

(72) Inventor: Kenji Uegaki, Susono-shi (JP)

(73) Assignee: TOYOTA JIDOSHA KABUSHIKI KAISHA, Toyota-shi Aichi-ken (JP)

(21) Appl. No.: 13/634,756

(22) PCT Filed: Apr. 22, 2010
(86) PCT No.: PCT/JP2010/057157

§ 371 Date: Sep. 13, 2012

(51) Int. Cl. B64C 25/58; F16F 7/12

(52) U.S. Cl. 244/100 R; 188/377

(57) ABSTRACT

An object of the invention is to provide an energy absorption structure that can suppress the fall of an energy absorption member when a load is applied to the energy absorption structure. According to the energy absorption structure of the invention, when a load is applied to the energy absorption structure, the relative displacement between a first member and an energy absorption member is suppressed by a displacement suppressing member that connect the first member with the energy absorption member. Accordingly, the fall of the energy absorption member can be suppressed.

### TECHNICAL FIELD

The present invention relates to an energy absorption structure that absorbs impact energy.

### BACKGROUND ART

In the past, for example, a landing shock absorber of a rotorcraft disclosed in the following Patent Literature 1 has been known as a shock absorber that absorbs impact energy. In this landing shock absorber, a floor board and a seat lower portion positioned under a seat are separably connected to each other by shear pins and shock absorption means formed of honeycomb cores is disposed under the seat lower portion.

When a predetermined impact load is applied to the landing shock absorber, the shear pins are fractured. Accordingly, the seat lower portion is separated from the floor board, moves down, and is supported by the honeycomb cores. Further, impact energy is absorbed through the plastic deformation of the honeycomb cores.

### CITATION LIST

### Patent Literature

[Patent Literature 1] Japanese Unexamined Patent Application Publication No. 2006-232075

### SUMMARY OF INVENTION

### Technical Problem

However, in such a landing shock absorber, there is a concern that the energy absorption means does not function due to the occurrence of the lateral fall of the shock absorption means when a fuselage tilts at the time of an emergency landing or the like.

Accordingly, an object of the invention is to provide an energy absorption structure that can effectively absorb load energy by suppressing the fall of the shock absorption member when a load is applied to the energy absorption structure.

### Solution to Problem

That is, according to an aspect of the invention, there is provided an energy absorption structure including an energy absorption member that is installed adjacent to a first member and absorbs energy and displacement suppressing member that suppresses the relative displacement between the first member and the energy absorption member. The displacement suppressing member connects the first member with the energy absorption member.

According to the aspect of the invention, when a load is applied to the energy absorption structure, the relative displacement between the first member and the energy absorption member is suppressed by the displacement suppressing member that connects the first member with the energy absorption member. Accordingly, it is possible to effectively absorb load energy by suppressing the fall of the energy absorption member.

Further, in the energy absorption structure according to the aspect of the invention, the displacement suppressing member may be disposed across a contact portion between the first member and the energy absorption member.

Here, the contact portion may be formed by not only the direct contact between the first member and the energy absorption member by but also the indirect contact between the first member and the energy absorption member with another member interposed between the first member and the energy absorption member.

Accordingly, since the contact portion and the vicinity thereof are connected, the relative displacement between the first member and the energy absorption member is further suppressed and the fall of the energy absorption member is suppressed. Accordingly, it is possible to effectively absorb load energy.

Furthermore, in the energy absorption structure according to the aspect of the invention, the first member may be a fuselage frame of an airplane, and the displacement suppressing member may connect side surfaces of the fuselage frame, which is adjacent to a contact portion between the fuselage frame and the energy absorption member, with side surfaces of the energy absorption member that is adjacent to the contact portion. There are many airplanes of which fuselages are formed in a curved surface shape. Accordingly, a component force making an energy absorption member fall down may be generated even though a fuselage does not tilt at the time of emergency landing or the like. However, according to the aspect of the invention, it is possible to effectively absorb load energy by suppressing the fall of the energy absorption member even in such an airplane.

Moreover, in the energy absorption structure according to the aspect of the invention, the thicknesses of the displacement suppressing member may be maximum at the contact portion and may be reduced with distance from the contact portion. Accordingly, since it is possible to improve connection strength while suppressing the increase in weight, it is possible to effectively absorb load energy by effectively suppressing the relative displacement between the first member and the energy absorption member and suppressing the fall of the energy absorption member.

Further, in the energy absorption structure according to the aspect of the invention, the displacement suppressing member may be fibrous members, and one ends of the displacement suppressing member may be disposed on side surfaces of the first member and spread radially and the other ends of the displacement suppressing member may be disposed on side surfaces of the energy absorption member and spread radially, so as to cover a contact portion between the first member and the energy absorption member. Accordingly, since the relative displacement between the first member and the energy absorption member is suppressed, it is possible to effectively absorb load energy by suppressing the fall of the energy absorption member.

Furthermore, in the energy absorption structure according to the aspect of the invention, the first member may be a fuselage frame of an airplane; the energy absorption member may be formed of a plurality of hollow columnar cells that extend from a contact portion between the fuselage frame and the energy absorption member and are arranged side by side so as to form a honeycomb structure; the displacement suppressing member may be a plurality of fibrous members; and one ends of the displacement suppressing member may be disposed on side surfaces of the fuselage frame adjacent to the contact portion and spread radially from end portions of the contact portion as center points and the other ends of the displacement suppressing member may be disposed on side surfaces of the cells and spread radially from the center points. Accordingly, it is possible to effectively absorb load energy by suppressing the fall of the energy absorption member even in an airplane where there is a concern about the fall of the energy absorption member as described above.

### Advantageous Effects of Invention

According to the invention, it is possible to provide an energy absorption structure that can effectively absorb load energy by suppressing the fall of the energy absorption member when a load is applied to the energy absorption structure.

### BRIEF DESCRIPTION OF DRAWINGS

FIG. 1 is a schematic view showing an energy absorption structure according to an embodiment of the invention together with an airplane.

FIG. 2 is a view taken along line II-II of FIG. 1.

FIG. 3 is a perspective view showing an overlay fall suppressing member of the energy absorption structure shown in FIG. 2.

FIG. 4 is a cross-sectional view showing the overlay fall suppressing member of the energy absorption structure shown in FIG. 2.

FIG. 5 is a perspective view showing a roving fall suppressing member of the energy absorption structure shown in FIG. 2.

### DESCRIPTION OF EMBODIMENTS

An embodiment of the invention will be described in detail below with reference to the drawings.

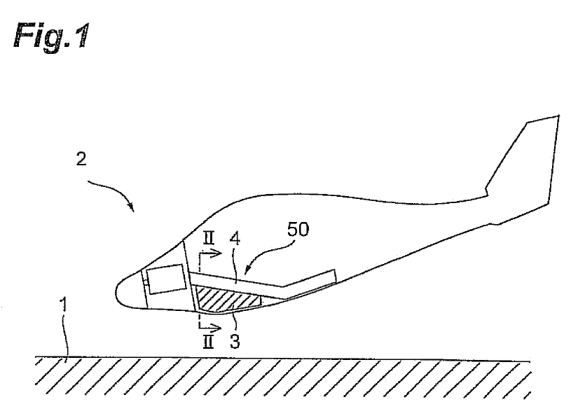

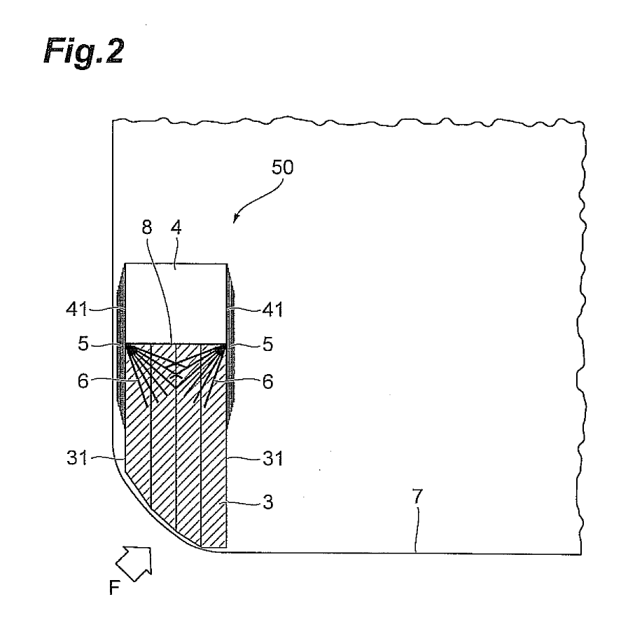

FIG. 1 is a schematic view showing an energy absorption structure according to an embodiment of the invention together with an airplane. Further, FIG. 2 is a view taken along line II-II of FIG. 1. Meanwhile, only one side structure of an airplane in the width direction of a fuselage is shown in FIG. 2.

As shown in FIG. 1, an energy absorption structure 50 according to an embodiment of the invention is mounted on an airplane 2. The energy absorption structure 50 is to absorb impact energy when the airplane 2 collides with the ground 1 or the like due to the emergency landing or the like. The energy absorption structure 50 is provided at the front and lower portion of the airplane 2. Further, as shown in FIG. 2, the energy absorption structure 50 includes an energy absorption member (hereinafter, abbreviated as an EA member) 3, an overlay fall suppressing member (displacement suppressing member) 5, and a roving fall suppressing member (displacement suppressing member) 6.

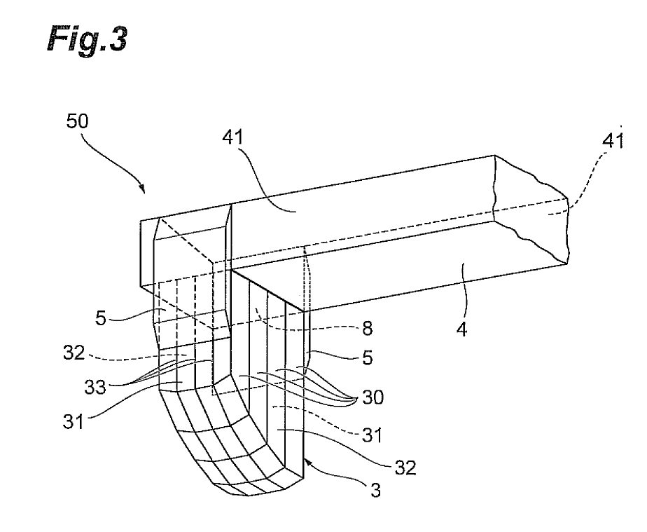

The EA member 3 is to absorb impact energy, and is installed at the front and lower portion of the airplane 2 so as to be adjacent to a fuselage frame (first member) 4 that extends in the longitudinal direction of the fuselage. Specifically, the EA member 3 is installed adjacent to the bottom of the fuselage frame 4, so that a contact portion 8 between the fuselage frame 4 and the EA member 3 is formed. Meanwhile, the contact portion 8 may be formed by not only the direct contact between the fuselage frame 4 and the EA member 3 but also the indirect contact between the fuselage frame 4 and the EA member 3 with another member interposed between the fuselage frame 4 and the EA member 3. The EA member 3 is formed of a plurality of hollow columnar cells 30 that extend from the contact portion 8 and are arranged side by side so as to form a honeycomb structure. The shape of a hollow polygonal prism such as, a hollow hexagonal prism or a hollow triangular prism, in addition to the shape of a hollow quadrangular prism shown in FIG. 3 may be used as the shape of the cell 30. EA member side surfaces 31 of the EA member 3 parallel to the longitudinal direction of the fuselage are disposed so as to be linearly or smoothly connected to frame side surfaces 41 of the fuselage frame 4 that are parallel to the longitudinal direction of the fuselage (so that differential coefficients at adjacent points are equal to each other), and an end face of the EA member 3 opposite to the contact portion 8 is formed so as to have a shape along a fuselage skin panel 7. It is preferable that fiber reinforced plastic (hereinafter, referred to as an FRP material) such as carbon fiber reinforced plastic, which has large effective stroke and excellent energy absorbing characteristics and is light, be used as a material of the EA member 3. However, aluminum or the like may be used as a material of the EA member 3. Further, a foam resin material, foam metal, or the like may be used instead of the member forming the honeycomb structure.

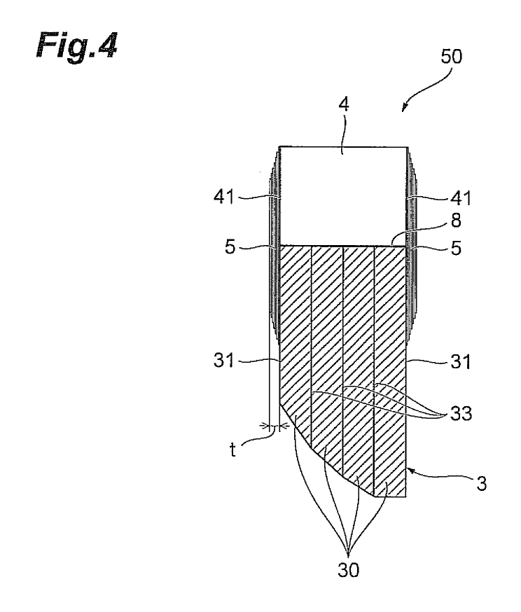

FIG. 3 is a perspective view showing the overlay fall suppressing member 5 of the energy absorption structure shown in FIG. 2. Moreover, FIG. 4 is a cross-sectional view showing the overlay fall suppressing member 5 of the energy absorption structure shown in FIG. 2.

The overlay fall suppressing member 5 is to suppress the relative displacement between the fuselage frame 4 and the EA member 3 caused by collision, and connect the fuselage frame 4 with the EA member 3. Specifically, as shown in FIG. 3, the overlay fall suppressing member 5 connects the frame side surfaces 41 of the fuselage frame, which is adjacent to the contact portion 8, with the EA member side surfaces 31 of the EA member 3 that are adjacent to the contact portion 8. That is, the overlay fall suppressing member 5 is disposed across the contact portion 8 between the fuselage frame 4 and the EA member 3. The overlay fall suppressing member 5 is provided on the outside in the width direction of the fuselage and on the inside in the width direction of the fuselage.

As shown in FIG. 4, the overlay fall suppressing member 5 is formed by bonding and joining (that is, overlay-joining) FRP materials to the frame side surfaces 41 and the EA member side surfaces 31 in the form of layers so that the frame side surfaces 41 and the EA member side surfaces 31 are coated with the FRP materials. Here, overlay joining is performed in the form of a staggered overlay so that the thicknesses of the overlay fall suppressing member 5 is maximum at the contact portion 8 and is reduced with distance from the contact portion 8 and an FRP material forming the lowermost layer, which is directly coated on the frame side surface 41 and the EA member side surface 31, is largest and the FRP materials gradually become small toward the upper layer. According to this configuration, it is possible to improve strength while suppressing the increase in weight. In addition, it is possible to reduce the costs of materials. Further, when the airplane 2 collides with the ground 1 or the like and a load is applied to the airplane 2, it is possible to suppress the buckling of the EA member 3 that is apt to occur at the upper portion of the inside of the EA member 3 in the width direction of the fuselage due to the superimposition of a compressive force applied to the EA member 3 and the moment making the EA member 3 fall down. Meanwhile, instead of an FRP material, a metal plate may be used as a member used for the overlay fall suppressing member 5.

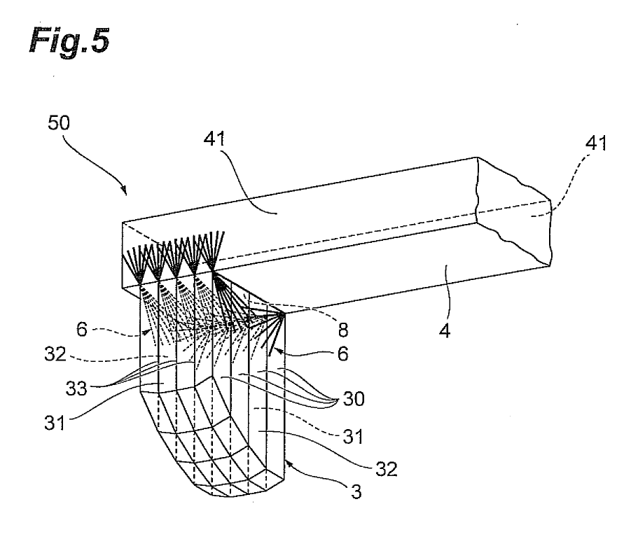

FIG. 5 is a perspective view showing the roving fall suppressing member 6 of the energy absorption structure shown in FIG. 2.

The roving fall suppressing member 6 is to suppress the relative displacement between the fuselage frame 4 and the EA member 3 caused by collision, and connect the fuselage frame 4 with the EA member 3. Specifically, the roving fall suppressing member 6 is a plurality of fibrous members, and one ends of the roving fall suppressing member 6 are disposed on the frame side surfaces 41 of the fuselage frame 4 and spread radially and the other ends of the roving fall suppressing member are disposed on cell side surfaces 32 and 33 of the cells 30, which are energy absorption members, and spread radially, so as to cover the contact portion 8. Here, the cell side surfaces 32 are side surfaces, which form the outer surfaces of the EA member 3 and are parallel to the width direction of the fuselage, among the side surfaces of the cells 30, and the cell side surfaces 33 are side surfaces that come into contact with adjacent cells 30 and are parallel to the width direction of the fuselage. In more detail, one ends of the roving fall suppressing member 6 are disposed on the frame side surfaces 41 and spread radially from the end portions of the contact portion 8 as center points, and the other ends of the roving fall suppressing member are disposed on the cell side surfaces 32 or 33 and spread radially from the same center points. The roving fall suppressing member 6 is provided on the outside in the width direction of the fuselage and on the inside in the width direction of the fuselage. It is preferable that a string-like FRP roving member obtained by bundling FRP fibers be used as the roving fall suppressing member 6. However, a thin metal wire or a string made of a synthetic resin may be used as the roving fall suppressing member 6.

The roving fall suppressing member 6 is provided by, for example, the following process. First, a FRP prepreg sheet or the like is wound on a core such as silicon to form the cell 30. In a step of forming the EA member 3 by piling up the cells 30, a plurality of string-like FRP roving members, which are immersed in a resin, are disposed so that the central portions of the FRP roving members are positioned at the above-mentioned center points, and one ends of the FRP roving members are made to spread radially and are laid up on the cell side surfaces 32 or 33 of the cells 30 so that the thickness of the FRP roving member is small. Then, the cells 30 are piled up thereon. The EA member 3 is completed by repeating this process.

After the EA member 3 is completed, the other ends of the FRP roving members are made to spread radially and are laid up on the frame side surfaces 41 of the fuselage frame 4 and the fuselage frame 4 and the EA member 3 are formed integrally with each other. In this way, the roving fall suppressing member 6 can be provided.

Next, the operation and effect of the energy absorption structure 50 according to this embodiment will be described.

When the airplane 2 collides with the ground 1 or the like due to the emergency landing or the like, a load F is applied to the airplane 2 as shown in FIG. 2. The bottom of the airplane 2 has a curved surface shape, and the air plane 2 collides with the ground 1 or the like with a forward speed. Accordingly, even though the airplane 2 collides with the ground 1 without tilting, the load F includes a component force that makes the EA member 3 fall down (a component force in the width direction of the fuselage or a component force in the longitudinal direction of the fuselage). Further, when the airplane 2 tilts in a roll direction (the direction of the rotation about the longitudinal direction of the fuselage as an axis) or a yaw direction (the direction of the rotation about the width direction of the fuselage as a central axis) and collides, a component force making the EA member 3 fall down acts even more. In particular, an interior width is small, for example, about 1.2 m and the width of the EA member 3 cannot be increased in the case of a four to six seater small airplane. For this reason, the EA member 3 is more apt to fall down.

If the load F is applied to the airplane 2, a component force in the vertical direction of the fuselage is absorbed through the plastic deformation of the EA member 3 of the energy absorption structure 50 or is absorbed through a gradual progressive destruction when the EA member 3 is made of a brittle material such as carbon fiber reinforced plastic. However, a component force in the width direction of the fuselage is to make the EA member 3 fall down inward in the width direction of the fuselage. However, since the energy absorption structure 1 according to this embodiment is provided with the overlay fall suppressing member 5, the separation of the EA member 3 from the fuselage frame 4 is suppressed on the outside in the width direction of the fuselage and the occurrence of breakage from corners of the EA member 3 is suppressed on the inside in the width direction of the fuselage. Accordingly, the inward fall of the EA member 3 in the width direction of the fuselage is suppressed, so that it is possible to effectively absorb load energy. Meanwhile, when the airplane 2 is a small airplane, an effect is more apt to be exerted.

Further, the thicknesses of the overlay fall suppressing member 5 is reduced with distance from the contact portion 8 in the energy absorption structure 1 according to this embodiment. Accordingly, even though a gradual progressive destruction occurs when the EA member 3 is made of a brittle material such as carbon fiber reinforced plastic or the EA member 3 is plastically deformed to the position of the overlay fall suppressing member 5 by a component force of the load F in the vertical direction of the fuselage, the overlay fall suppressing member 5 is apt to be deformed together with the EA member 3. Therefore, the energy absorbing function of the EA member 3 is less impaired.

Furthermore, in the energy absorption structure 1 according to this embodiment, the moment generated by a component force of the load F in the width direction of the fuselage is transmitted to the fuselage frame 4 by the tension of the roving fall suppressing member 6. Accordingly, the inward fall of the EA member 3 in the width direction of the fuselage is further suppressed, so that it is possible to effectively absorb load energy. Meanwhile, when the airplane 2 is a small airplane, an effect is more apt to be exerted.

Moreover, even though a gradual progressive destruction occurs when the EA member 3 is made of a brittle material such as carbon fiber reinforced plastic or the EA member 3 is plastically deformed to the position of the roving fall suppressing member 6 by a component force of the load F in the vertical direction of the fuselage, the energy absorbing function of the EA member 3 is less impaired since the roving fall suppressing member 6 is not disposed in a direction that significantly contributes to the absorption of energy. Further, since the roving fall suppressing member 6 is arranged in the width direction of the fuselage, the roving fall suppressing member 6 can transmit the load F in the width direction of the fuselage.

As described above, according to the energy absorption structure 50 of this embodiment, when a load is applied to the energy absorption structure 50, the relative displacement between the fuselage frame 4 and the EA member 3 is suppressed by the overlay fall suppressing member 5 and the roving fall suppressing member 6 that connect the fuselage frame 4 with the EA member 3. Accordingly, it is possible to effectively absorb load energy by suppressing the fall of the energy absorption member.

Meanwhile, the invention is not limited to the above-mentioned embodiment. The overlay fall suppressing member 5 has been provided parallel to the longitudinal direction of the fuselage in the energy absorption structure 50 according to the this embodiment, but may be provided parallel to, for example, the width direction of the fuselage in addition to this. Accordingly, it is possible not only to suppress the fall of the EA member 3 in the width direction of the fuselage but also to suppress the fall of the EA member in the longitudinal direction of the fuselage.

### INDUSTRIAL APPLICABILITY

According to the invention, it is possible to provide an energy absorption structure that can effectively absorb load energy by suppressing the fall of the energy absorption member when a load is applied to the energy absorption structure.

### REFERENCE SIGNS LIST

2: airplane
3: EA member (energy absorption member)
4: fuselage frame (first member)
5: overlay fall suppressing member (displacement suppressing member)
6: roving fall suppressing member (displacement suppressing member)
8: contact portion
30: cell
31: EA member side surface
32: cell side surface
33: cell side surface
41: frame side surface
50: energy absorption structure

1. An energy absorption structure comprising:
an energy absorption member that is installed adjacent to a first member and absorbs energy; and
a displacement suppressing member that suppresses the relative displacement between the first member and the energy absorption member,
wherein the displacement suppressing member connects the first member with the energy absorption member.

2. The energy absorption structure according to claim 1,
wherein the displacement suppressing member is disposed across a contact portion between the first member and the energy absorption member.

3. The energy absorption structure according to claim 1,
wherein the first member is a fuselage frame of an airplane, and
the displacement suppressing member connects side surfaces of the fuselage frame, which is adjacent to a contact portion between the fuselage frame and the energy absorption member, with side surfaces of the energy absorption member that is adjacent to the contact portion.

4. The energy absorption structure according to claim 2,
wherein the thicknesses of the displacement suppressing member is maximum at the contact portion and is reduced with distance from the contact portion.

5. The energy absorption structure according to claim 1,
wherein the displacement suppressing member is fibrous members, and
one ends of the displacement suppressing member are disposed on side surfaces of the first member and spread radially and the other ends of the displacement suppressing member are disposed on side surfaces of the energy absorption member and spread radially, so as to cover a contact portion between the first member and the energy absorption member.

6. The energy absorption structure according to claim 1,
wherein the first member is a fuselage frame of an airplane,
the energy absorption member is formed of a plurality of hollow columnar cells that extend from a contact portion between the fuselage frame and the energy absorption member and are arranged side by side so as to form a honeycomb structure,
the displacement suppressing member are a plurality of fibrous members, and
one ends of the displacement suppressing member are disposed on side surfaces of the fuselage frame adjacent to the contact portion and spread radially from end portions of the contact portion as center points, and the other ends of the displacement suppressing member are disposed on side surfaces of the cells and spread radially from the center points.

7. The energy absorption structure according to claim 3,
wherein the thicknesses of the displacement suppressing member is maximum at the contact portion and is reduced with distance from the contact portion.
